(19) United States
(12) Patent Application Publication
(10) Pub. No.: US 2023/0398555 A1
(43) Pub. Date: Dec. 14, 2023

(54) FLOTATION CELL VORTEX STABILIZER

(71) Applicant: FLSmidth A/S, Valby (DK)

(72) Inventors: Thien Sok, Sandy, UT (US); Ian Coltrin

(21) Appl. No.: 18/031,552

(22) PCT Filed: Oct. 12, 2021
(86) PCT No.: PCT/IB2021/059361

§ 371 Date: Apr. 12, 2023

Related U.S. Application Data
(60) Provisional application No. 63/090,309, filed on Oct. 12, 2020.

(51) Int. Cl. B03D 1/14; B03D 1/18

(52) U.S. Cl. CPC B03D 1/1493; B03D 1/18

(57) ABSTRACT

A self-aspirated froth flotation cell 100 may include a slurry vortex stabilizer 166 having an annular body 234 with an upper annular edge 176 and an aperture 180 extending through a central region of the annular body 234. The aperture 180 may have an inner surface 182 bounded between an upper inner edge 178 and a lower inner edge 200 that is configured to allow the drive shaft 142 to rotate freely therein in close proximity to the inner surface 182. The slurry vortex stabilizer 166 may have an annular undersurface 210 configured with a inner first portion 212, a second portion 236 provided around the first portion 212, and an annular intersection, transition, or inflection 214 therebetween. A sloped upper surface 242 which tapers downwardly towards the central region of the annular body 234 as it approaches the aperture 180 forms a lower fluid surface boundary within a standpipe 152 of the self-aspirated froth flotation cell 100.

### FIELD OF THE INVENTION

This invention relates to froth flotation cells, particularly froth flotation cells utilized for removing mineral values from ore slurries. The invention aims to prevent or discourage the formation of a slurry vortex within a standpipe of a froth flotation cell. Accordingly, embodiments described herein help to reduce surface instabilities at a pulp-froth interface inside the froth flotation cell.

### BACKGROUND OF THE INVENTION

Froth flotation cells are used to separate mineral values from mineral wastes. An ore is finely ground and suspended as a water-based slurry or pulp in a flotation cell. An impeller or rotor is turned at a high speed in the slurry to suspend the mineral particulates and to distribute or disperse air bubbles into the slurry. The mineral values attach to the air bubbles. The bubbles with the entrained mineral values then rise to form a froth atop the pulp or slurry pool. The froth overflows a weir and is collected in a launder for further processing. Some examples of flotation cells are described in U.S. Pat. No. 5,611,917 to Degner; U.S. Pat. No. 4,737,272 to Szatkowski et al.; U.S. Pat. No. 3,993,563 to Degner; U.S. Pat. No. 6,095,336 to Redden et al.; and U.S. Pat. No. 6,070,734 to Hunt et al.

As depicted in FIGS. 1 and 2, froth flotation cells of the above-described type, in particular, self-aspirated froth flotation cells, may include a vertical standpipe (or tube) 2, which is concentric or coaxial with a rotor (or impeller) 4, and a longitudinal axis A, B. The standpipe 2 is mounted proximate an upper portion of the froth flotation cell. With reference to FIG. 1, the general action of the rotor 4 and standpipe 2 assembly within the froth flotation cell results in air or other gas being ingested into slurry or other mixture by virtue of being sucked down along general direction 3. Slurry or other mixture is sucked up along general direction 5, and a resulting bubbly jet stream is distributed in general direction 7, eventually helping to form a froth atop or proximate the pulp-froth interface 8. Furthermore, the rotor's 4 action also usually generates, in the standpipe 2, a slurry vortex 6 that is unstable due to pressure fluctuation in the rotor region. The slurry vortex 6 jumps (e.g., up and down) periodically, from a low level or height shown in FIG. 1 to a high level shown in FIG. 2.

The instability of the slurry vortex 6 varies the degree of submergence of the rotor 4 and produces a fluctuating air-inflow rate. As a result, multi-phase jet characteristics such as void fraction and velocity become unstable. The unstable jet stream generates waves at the pulp-froth interface 8 within the tank of the froth flotation cell and makes the level of the pulp-froth interface 8 sway periodically. These waves (and swaying action) can make it difficult to control the pulp-froth interface 8 level and operate froth flotation cells in applications where the froth height is relatively low. The waves generated can allow the pulp below the pulp-froth interface 8 to splash into the launder and negatively impact flotation machine performance. It is also desirable to be able to set a pulp-froth interface 8 level and control its location because this has an effect on the grade and recovery of the flotation device. When the surface is unstable, the level of height of the pulp-froth interface 8 varies, and, as a result, this parameter can be difficult or near impossible to set, change, or control.

Some attempts have been made to mitigate the negative effects of slurry vortex formation 6 within a froth flotation cell. For example, a standpipe design (shown in WO 2013/067343), aims stabilize a slurry vortex 6 by placing curved baffle surfaces within inner surfaces of a standpipe to counteract slurry flows within the standpipe. The present invention, as will be appreciated hereinafter, seeks a completely different mechanism to counteract slurry vortex 6 formation/instability.

### OBJECTS OF THE INVENTION

An aim of embodiments of the present invention is to provide an improved froth flotation cell 100 wherein a slurry vortex 6 forming in the standpipe 2 may be stabilized and/or prevented from forming, without limitation.

Another aim of embodiments of the present invention is to provide improved apparatus for preventing a slurry vortex 6 from affecting pulp or slurry movements within the tank 112 of a froth flotation cell 100, thereby improving machine performance and recovery, without limitation.

Yet another aim of embodiments of the present invention is to provide improved apparatus for preventing or discouraging the ingress of slurry into a standpipe 152 from a froth flotation cell tank 112 during operation, without limitation.

Yet another aim of embodiments of the present invention is to provide improved apparatus for minimizing the amount of mass and/or volume of slurry that can remain in a standpipe 152, without limitation.

Yet another aim of embodiments of the present invention is to provide improved apparatus for minimizing height changes and non-stable dynamic movements of slurry within a standpipe 152, without limitation.

A further aim of embodiments of the present invention is to provide an apparatus (e.g., slurry vortex stabilizer 166) that may be easily retrofitted into existing froth flotation cells to help quell, diminish, or eliminate problematic wave formations of pulp or slurry within a froth flotation cell tank 112 that are caused by the formation of a slurry vortex 6 within a standpipe 152 during froth flotation cell operation.

A related aim is to provide stabilizing structures which more effectively combat detrimental effects associated with slurry vortex 6 formation and movement, and which demonstrate increased performance over prior designs intended for stabilizing a slurry vortex 6 in a froth flotation cell (e.g., such as the standpipe design shown in WO 2013/067343), without limitation.

### SUMMARY OF THE INVENTION

A slurry vortex stabilizer 166 is disclosed. A self-aspirated froth flotation cell 100 may comprise the slurry vortex stabilizer 166. The slurry vortex stabilizer 166 may be configured for placement within a tank 112 of a self-aspirated froth flotation cell 100. The slurry vortex stabilizer 166 may, for instance, be configured for placement above a rotor 114 of the self-aspirated froth flotation cell 100, without limitation. The slurry vortex stabilizer 166 may be configured to surround a drive shaft 142 supporting and driving rotation of the rotor 114.

The slurry vortex stabilizer 166 may comprise an annular body 234. The annular body 234 may have an upper annular edge 176. The annular body 234 may have an aperture 180 extending through a central region of the annular body 234. The aperture 180 may have an inner surface 182 bounded between an upper inner edge 178 and a lower inner edge 200. The inner surface 182 may be configured to allow the drive shaft 142 to rotate freely therein, in close proximity to the inner surface 182.

An annular undersurface 210 of the slurry vortex stabilizer 166 may comprise an inner first portion 212 and a second portion 236. The second portion 236 may be provided around the first portion 212. An annular intersection, transition, or inflection 214 may be provided between the first 212 and second 236 portions. The annular undersurface 210 of the annular body 234 may be configured to be provided radially-inwardly of a disperser hood 136 in the self-aspirated froth flotation cell 100.

The slurry vortex stabilizer 166 may further comprise a sloped upper surface 242. The sloped upper surface 242 may taper downwardly towards the central region of the annular body 234 as it approaches the aperture 180. The first portion 212 may be located radially-inwardly of the second portion 216 with respect to an axis of rotation 118 of the drive shaft 142 and/or rotor 114. The first portion 212 may be located closer to the aperture 180, lower inner edge 200, and/or inner surface 182 of the aperture 180 than the second portion 216. In some embodiments, the sloped upper surface the annular body 234 may be configured to be provided radially inward of surfaces of a disperser 134 or disperser hood 136 within the self-aspirated froth flotation cell 100.

The aperture 180 may extend concentrically through the annular body 234. For example, radial distances between the upper inner edge 178 and upper annular edge 176 may be equidistant around the slurry vortex stabilizer 166.

In some embodiments, the sloped upper surface 242 may comprise a concave dished upper surface 174. For example, the sloped upper surface 242 may comprise a frustospherical surface. The sloped upper surface 242 may, in some embodiments, comprise an angled floor 222. The angled floor 222 may comprise a faceted surface (e.g., a flat planar surface), a frustoconical surface, a frustospherical surface, a concave surface, a dished surface, or a combination thereof, without limitation.

The first portion 212 may comprise a convex, frustospherical, or frustoconical surface. The second portion 236 comprises a concave, dished, or tapered surface. The concave, dished, or tapered surface may narrow towards (i.e., as it approaches) the intersection or transition 214.

The slurry vortex stabilizer 166 may comprise a number of webs 218 extending upwardly from the sloped upper surface 242. For example, each web 218 may define at least one interface 230 (e.g., intersection, transition, or corner region) between a sloped upper surface 242 and a surface of the respective web 218.

Webs 218 may be provided between (e.g., extend between) the upper annular edge 176 (or upper annular rim 226) and an external wall 224 of a central hub 220. At least one interface 228 may be defined between the external wall 224 of the central hub 220 and a portion of the sloped upper surface 242 (e.g., an angled floor 216). The central hub 220 is preferably tubular and has a cylindrical shape (e.g., defined at least in part by the inner surface 182 of aperture 180 and the external wall 224), without limitation.

If present, the webs 218 may extend at any angle with respect to a tangent of the external wall 224 or with respect to a surface of the sloped upper surface 242. Webs 218 may also be skewed, offset (e.g., radially), curved, or slanted in any one or more of the axes D, 118, 118′, 118″, without limitation. As shown, the webs 218 may extend radially with respect to the body 234 and toward a center of aperture 180, and extend orthogonally upward from the sloped upper surface 242, without limitation.

The slurry vortex stabilizer 166 may comprise a disperser hood 136. The disperser hood 136 may be integrally provided to the slurry vortex stabilizer. For example, the slurry vortex stabilizer 166 and disperser hood 136 may share the same monolithic and unitary structure, such that the two may not be separable from one another.

The slurry vortex stabilizer 166 may comprise an upper collar 184. A gap 190 may be present between an outer peripheral surface 188 of the annular body 234 and the upper collar 184 of the disperser hood 136. The gap 190 may be configured for receiving a lower portion of a standpipe 152 that is positioned within the self-aspirated froth flotation cell 100. The upper collar 184 may comprise at least one mounting feature 194 for mounting the upper collar 184 to the standpipe 152.

The disperser hood may comprise a lower bell 196. The lower bell 196 may extend downwardly and radially-outwardly from the upper collar 184. The lower bell 196 may comprise an upper bell surface 202, a lower bell surface 208, and a lower outer peripheral surface 206. A number of perforations or openings 204 may extend through the upper 202 and lower 208 bell surfaces and through the lower bell 196. The upper bell surface 202 and lower bell surface 208 may be frustoconical as shown, but may have a dished or other shape, without limitation.

The sloped upper surface 242 of the body 234 may be configured to form a lower fluid boundary surface within the standpipe 152. One or more mounting features 232 for securing the annular body 234 to a separable detachable disperser hood 136 and/or to a separable detachable disperser 134. The slurry vortex stabilizer 166 may be configured for attachment to both the disperser 134 and disperser hood 136 via the one or more mounting features 232. The body 234 of the slurry vortex stabilizer 166 may be located radially inward from the disperser 134. The disperser 134 may surround an outer peripheral surface 188 annular body 234.

In some embodiments, the upper collar 184 may be modular. For example, the upper collar 184 may comprise an upper portion 184a defining a portion of a disperser 134, and a lower portion 184b defining a portion of a disperser hood 136. In such embodiments, the upper portion 184a may be separable from the lower portion 184.

A method of performing a flotation operation is also disclosed. The method operation may comprise the step of providing a slurry vortex stabilizer as described above within a tank 112 of the self-aspirated froth flotation cell 100, around the drive shaft 142 and/or above the rotor 114 such that the inner surface 182 of the aperture 180 surrounds the drive shaft 142. The method may further include the step of rotating the rotor 114 and drive shaft 142 while slurry is held within the tank 112. The method may further include the step of drawing air into the slurry within the tank 112. The method may further include the step of preventing the formation of a slurry vortex 6 or waves in the slurry in the tank by virtue of the provision of the slurry vortex stabilizer 166 within the tank 112.

### BRIEF DESCRIPTION OF THE DRAWINGS

FIG. 1 is a schematic cross-sectional view of a conventional standpipe 2 of a froth flotation cell, showing one possible condition of a slurry vortex 6 inside the standpipe.

FIG. 2 is a schematic cross-sectional view which is similar to FIG. 1, showing another possible condition of a slurry vortex 6 inside the standpipe 2.

FIG. 3 is a side view, partially cut away and in section, of a froth flotation cell 100 in accordance with an embodiment of the present invention.

FIG. 4 is an upper isometric perspective view of a vortex-stabilizing device according to some embodiments.

FIG. 5 is a lower isometric perspective view of the vortex-stabilizing device of FIGS. 3 and 4.

FIG. 6 is a partial isometric vertical cross-sectional view showing an installed vortex-stabilizing device in accordance with another embodiment of the invention.

FIG. 6 is a side plan view of the assembly shown in FIG. 6.

FIGS. 8-10 illustrate the separable slurry vortex stabilizing device shown in FIGS. 5-7.

FIGS. 11-17 illustrate an embodiment comprising a vortex-stabilizing device in accordance with another embodiment of the invention.

### DETAILED DESCRIPTION

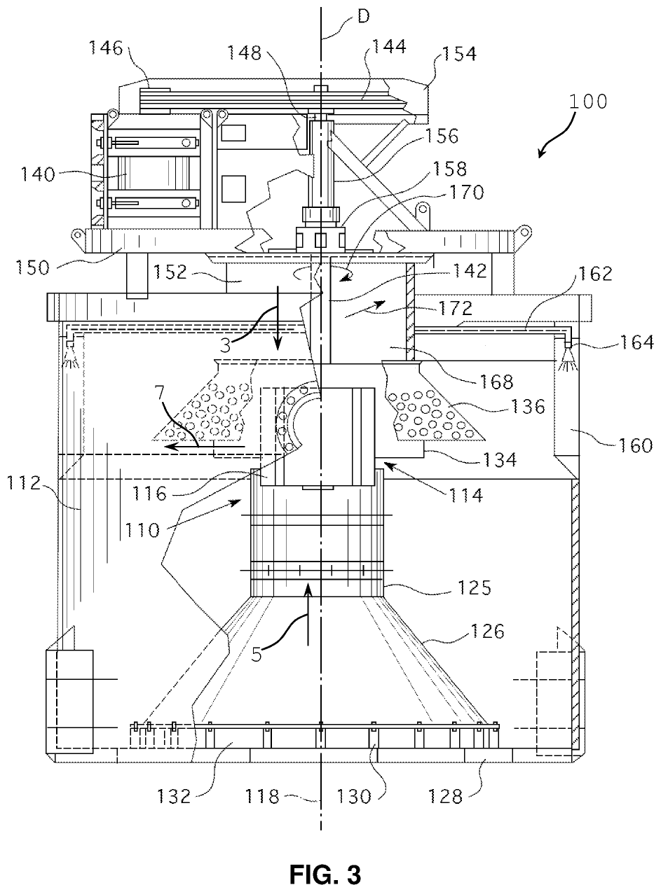

As illustrated in FIG. 3, a self-aspirated froth flotation cell 100 may comprise a rotor assembly rotatably disposed in a tank 112. The rotor assembly may be configured for pumping a pulp or slurry together with air to mix the air into the pulp or slurry. The rotor assembly may also be configured for generating a froth or bubble mass which floats atop a pulp mass or slurry pool in the tank 112. The rotor assembly may include a mixing structure in the form of a rotor (i.e., impeller) 114 comprising a plurality of vanes 116 (i.e., blades) 116. The vanes 116 may, as shown, be disposed in a generally even configuration about a rotation axis 118 (which may be aligned with a longitudinal axis D of the froth flotation cell), however, the vanes 116 may take forms and be arranged with respect to each other in ways other than what is shown. The tank 112 may be generally cylindrical as shown, or it may have a box shape or other shape (e.g., hexagonal), without limitation.

A lower end of the rotor 114 may be juxtaposed to an upper end of a draft tube assembly 110. As shown, the lower end of rotor 114 may be juxtaposed to an upper end of a cylindrical draft tube extension (i.e., spacer element) 125, which is coupled at a lower end thereof to a conical draft tube 126. Conical draft tube 126 may be spaced from a lower wall or panel 128 of tank 112 by a plurality of supports 130. Supports 130 may define a plurality of openings 132 through which pulp or slurry can move into the conical draft tube 126. During operation, the pulp or slurry is drawn through the openings 132 and into the conical draft tube 126, up the cylindrical draft tube extension 125, and towards the rotor 114. By virtue of surfaces of the rotor 114 (and/or vanes 116) being disposed within and/or in close proximity of the draft tube 110, the rotor 114 may act to pump the pulp or slurry through the openings 132, upwardly into the draft tube 110, and then radially outwardly (e.g., through an optional stationary fenestrated disperser 134 and/or disperser hood 136) along general direction 7, without limitation.

An upper end of the rotor 114 may be surrounded by an optional stationary fenestrated disperser 134. The disperser 134 may be tubular in design and preferably arranged to be coaxial with rotor 114. When employed, disperser 134 may serve to facilitate shearing of air bubbles formed by rotation of the rotor 114 and/or to reduce the energy after mixing of air and pulp. Positioned over and/or circumferentially about the disperser 134 (where used) and surrounding rotor 114 may be a perforated conical disperser hood 136 for stabilizing the pulp surface. The disperser hood 136 may at least partially envelop or surround upper outer portions of the disperser 134 and/or rotor 114 as shown in FIGS. 3, 6, and 7. Portions of the disperser hood 136 may circumferentially surround the disperser 134 and rotor 114, and surfaces of the disperser hood 136 may be located further radially-outwardly than surfaces of the disperser 134 and rotor 114 as shown. The disperser hood 136 may be mounted to an upper portion of the disperser 134, for example proximate a tube portion 238 or collar 184, 184a of the disperser 134. The rotor 114 may be positioned near the middle or upper regions of the fluid volume of tank 112 and the disperser hood 136 may generally function to calm the turbulent fluid in that region, thus avoiding disruptions to bubble-particle agglomerations occurring within tank 112 radially outside of the disperser disperser hood 136 which are critical to recovery and froth flotation performance.

Rotor 114 may be operatively connected to a motor 140 via a drive shaft 142, one or more transmission belts 144, and one or more sheaves 146 and 148 as depicted in FIG. 3. Motor 140 may be supported on tank 112, for example, via a mechanism stand 150, a base plate and standpipe 152, while transmission belts 144 and sheaves 146 and 148 may be covered by a belt guard 154, without limitation. A bearing housing 156 may surround drive shaft 142 along an upper portion thereof, and a slide gate air control device 158 may be disposed at the lower end of bearing housing 156.

The tank 112 of the froth flotation cell may be provided along an upper end thereof with a froth overflow weir (i.e., launder) 160 which is configured to receive froth and channel it away from the froth flotation cell 100. A pipe 162 (e.g., galvanized pipe) and one or more nozzle elements 164 provided thereto may be provided to the froth flotation cell for delivering cleaning fluid and spraying/washing/cleaning froth in launder 160. Optionally, one or more nozzle elements 164 may be provided to the pipe 162 for cleaning froth at various locations around the top of tank 112, without limitation.

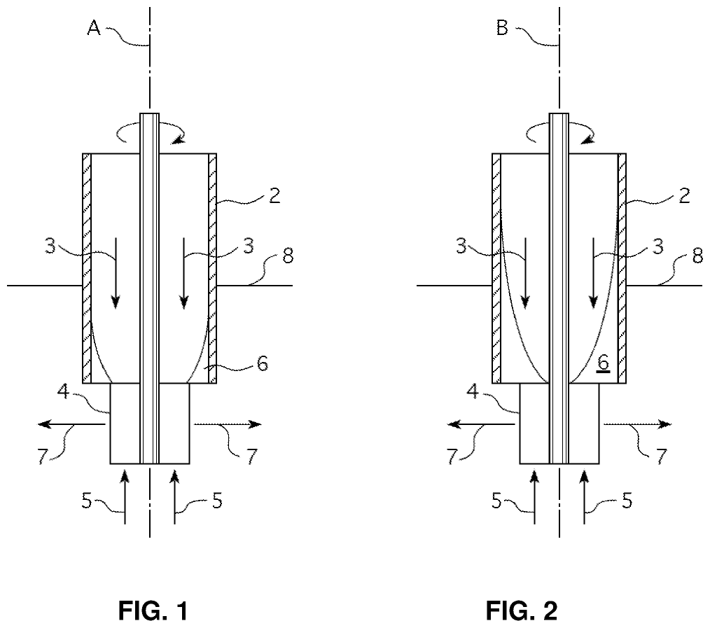

A standpipe 152 may be mounted at least partially inside tank 112 proximate an upper end of the rotor 114. The standpipe 152 facilitates ingesting of air in to pulp or slurry within tank 112 by virtue of rotor 114 spinning along axis 118. As air is ingested into standpipe 152, a fluctuating height slurry vortex 6 traditionally develops within standpipe 152 as described in the background of this description and depicted in FIGS. 1 and 2. It should be understood that the overall size, mass, and/or volume of the slurry vortex 6, as well as the adverse fluodynamic effects to slurry or pulp within tank 112 that are caused by the slurry vortex 6 will be appreciably diminished in the presence of a novel slurry vortex stabilizer 166 as will be described hereinafter in more detail.

For example, during operation of the froth flotation cell 100, as the drive shaft 142 rotates (see arrow 170), a slurry vortex 6 with a somewhat upward velocity vector 172 may form. To combat this, a slurry vortex stabilizer 166 according to the invention is provided below and/or within the standpipe 152, above the rotor 114 and around the drive shaft 142. The slurry vortex stabilizer 166 may, in some embodiments, be positioned, for example, between a disperser 134 and the standpipe 152, radially inward of the disperser hood 136, without limitation. The slurry vortex stabilizer 166 serves to combat the formation of the slurry vortex 6 in the first place, control and mitigate movement and fluodynamic effects of a formed slurry vortex 6, and/or combat disruptions to pulp or slurry within the tank 112 which might be caused by consequential dynamic movements of the slurry vortex 6, without limitation.

By virtue of its design, the slurry vortex stabilizer 166 may be configured to substantially fluidly-isolate the region inside of the standpipe 152 from contents within the tank 112 (e.g., pulp or slurry). Embodiments of the slurry vortex stabilizer 166 may be uniquely adapted to discourage slurry or pulp within tank 112 from migrating upward into the standpipe 152 by virtue of its body 234, thereby providing a substantial physical barrier between the drive shaft 142 and inner fluid boundaries of the standpipe 152. By minimizing the amount of tank 112 contents that can move up into the standpipe 152 from the tank 112 (via a tortuous path between the slurry vortex stabilizer 166 and rotating drive shaft 142), the overall mass and/or height of any slurry vortex 6 that can be generated in the standpipe can be controlled, minimized, or eliminated entirely. Said differently, in the presence of the novel slurry vortex stabilizer 166 described herein, the mass or volume of slurry that may be able to find its way into and/or remain within the standpipe 152 during froth flotation cell 100 operation will have a much-reduced negative impact on overall fluid dynamic environments occurring within the tank 112. For example, any fluctuations in height of a diminished slurry vortex 6 present in the standpipe 152 will have less ability to form disruptions such as waves within tank 112 due to a lesser possible hydrostatic head pressure and/or downward slurry momentum.

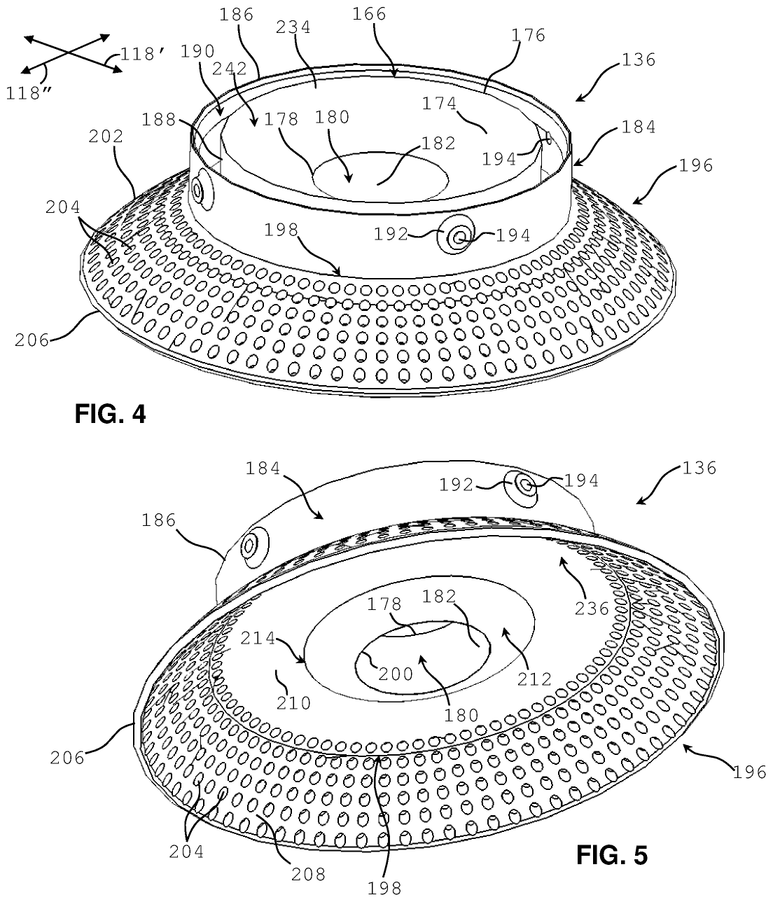

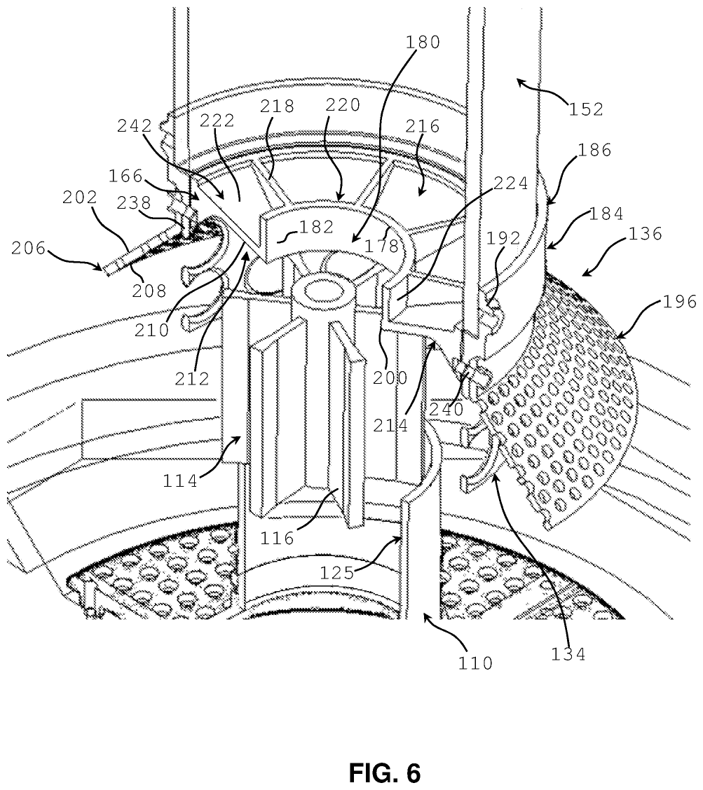

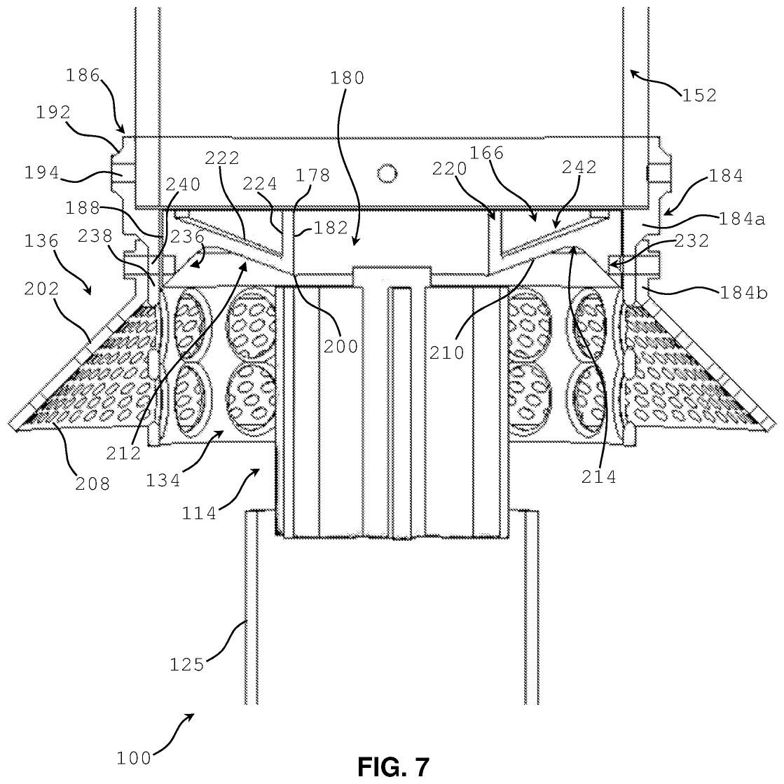

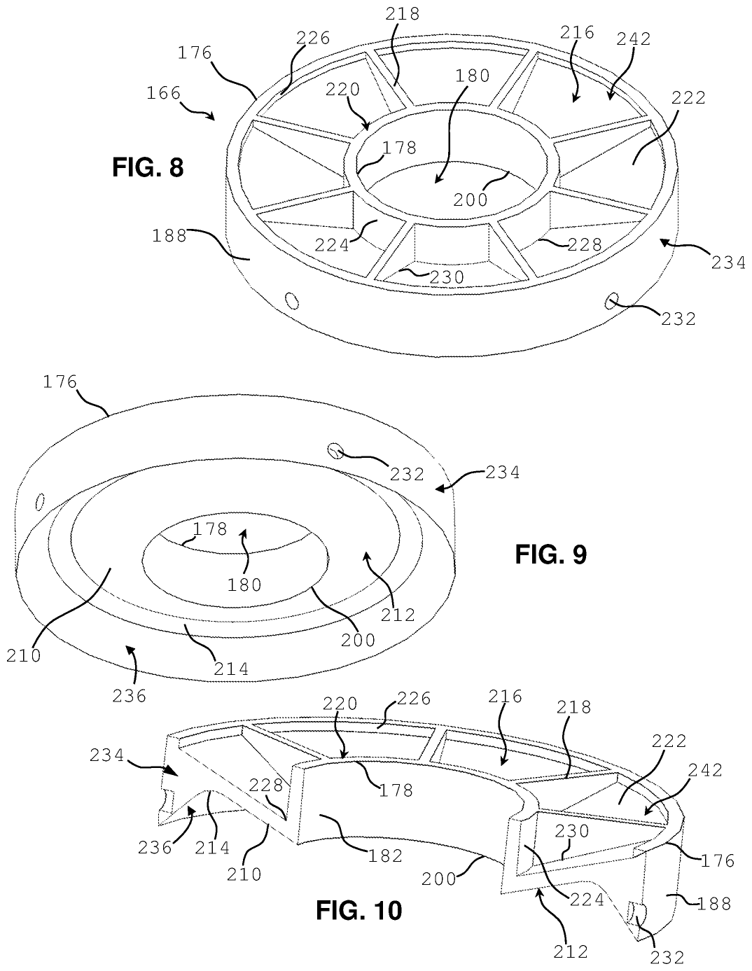

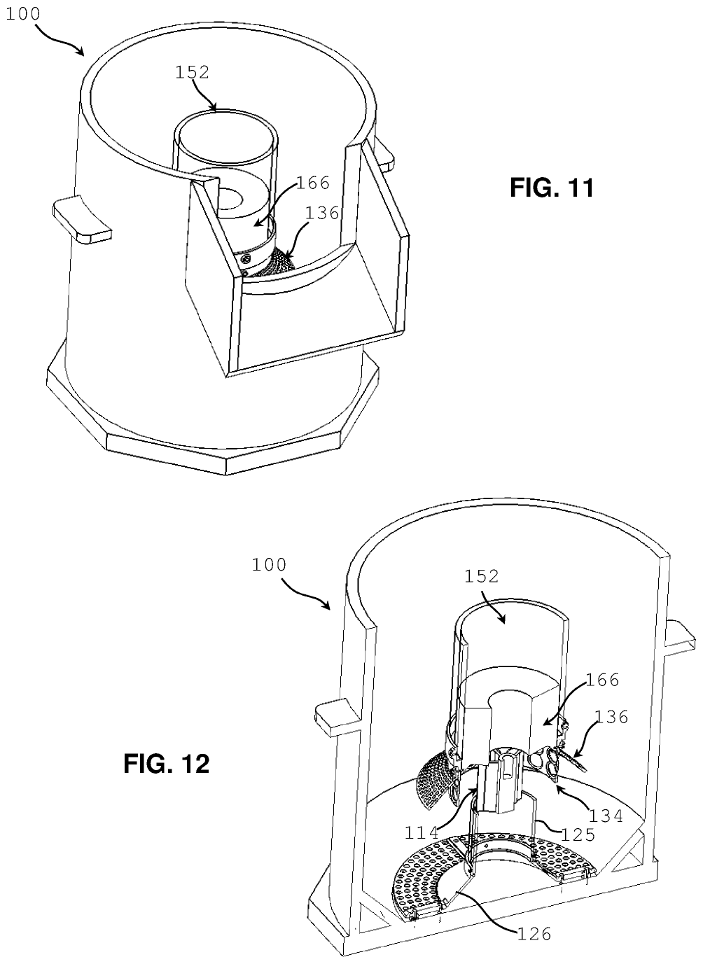

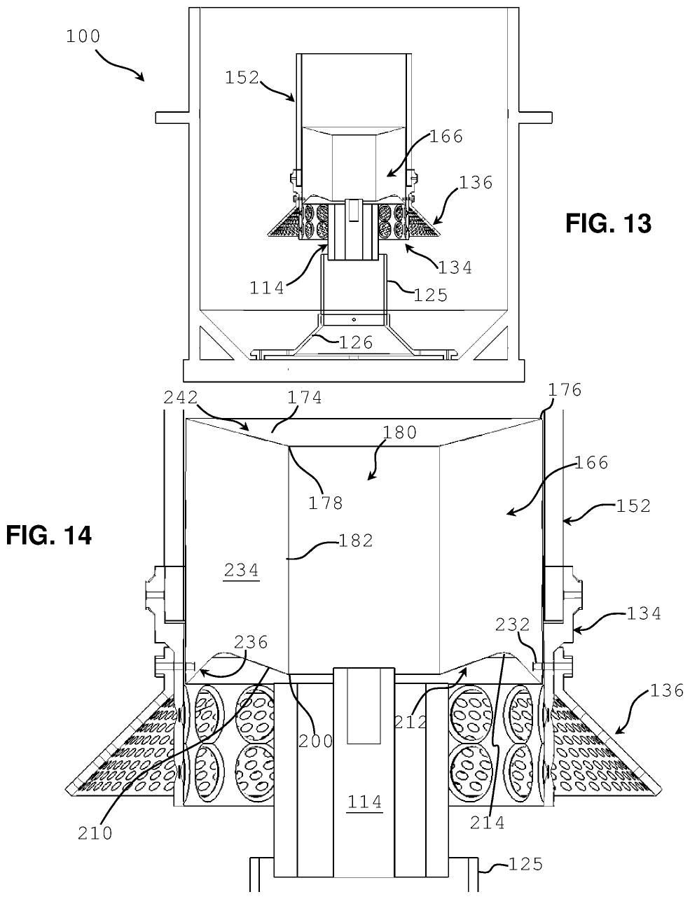

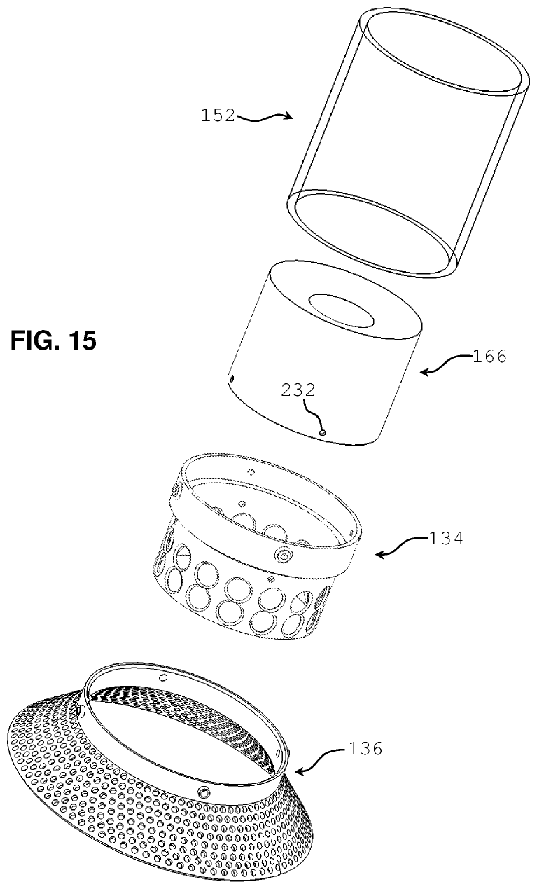

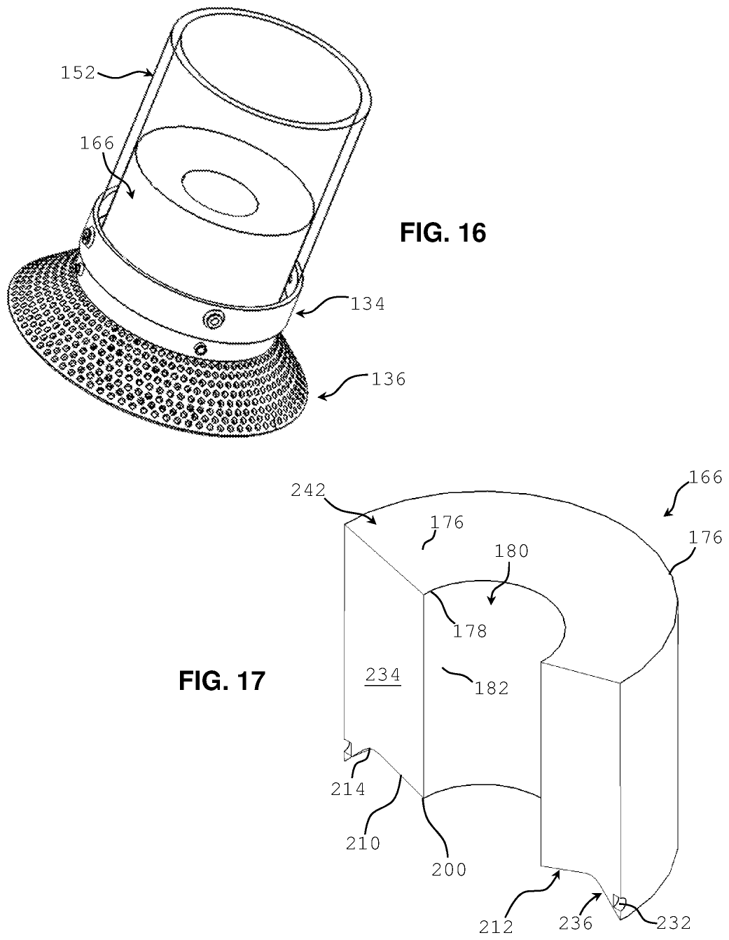

FIGS. 4 and 5 show a first non-limiting embodiment of a slurry vortex stabilizer 166 which can be placed within a self-aspirated froth flotation cell 100 according to the invention. FIGS. 6-10 show a second non-limiting embodiment of a slurry vortex stabilizer 166 which can be placed within a self-aspirated froth flotation cell 100 according to the invention. As discussed in the aforementioned paragraph, the slurry vortex stabilizer 166 is generally configured to close off a majority of the open area that would otherwise exist between the drive shaft 142 and a standpipe 152 above a rotor 114 in a self-aspirated froth flotation cell 100 lacking the presence of the novel slurry vortex stabilizer 166.

Slurry vortex stabilizer 166 may be made integral (i.e., monolithic with) a disperser hood 136 as shown in FIGS. 4 and 5; or, it may be configured to be separable from and attachable to a disperser hood 136 as suggested in FIGS. 6-10. The slurry vortex stabilizer 166 may be configured for receiving, abutting, and/or attaching to portions of a standpipe 152, such as a lower standpipe region 168. The slurry vortex stabilizer 166 may be configured for abutting and/or attaching to an optional disperser 134 (e.g., a stationary tubular device provided with a number of openings therethrough) as depicted in FIGS. 3, 6, and 7.

A slurry vortex stabilizer 166, according to embodiments of the invention, may comprise a body 234 having a sloped upper surface 242, an annular undersurface 210, and an outer peripheral surface 188. An upper annular edge 176 may surround the sloped upper surface 242 and define an upper peripheral edge of the body 234. In some embodiments (FIGS. 6-10), an annular upper rim or projection 226 may be present at or adjacent the upper annular edge 176, without limitation. The sloped upper surface 242 may comprise a concave or dished upper surface 174, such as a frustospherical surface (depicted in FIGS. 4 and 5); or, it may comprise an angled floor 222 (depicted in FIGS. 6-10). The angled floor may comprise frustoconical, frustopherical, concave, dished, or planar surfaces (e.g., facets), without limitation. The depth of the sloped upper surface 242 becomes shallower adjacent radially outward portions of the body 234 nearest the upper annular edge 176, and deeper towards a central aperture 180 extending through the body 234. The aperture 180 is configured to receive the drive shaft 142 and has an inner surface 182 (e.g., a cylindrical surface) defined between an upper inner edge 178 and a lower inner edge 200.

The annular undersurface 210 may comprise a first portion 212 and a second portion 236 separated by an intersection, transition, or inflection 214 therebetween. The first portion 212 and second portion 236 may have different surface shapes and/or profiles, without limitation. The first portion 212 may comprise a protruding surface, for example, a convex, frustospherical, or frustoconical surface, without limitation. The second portion 236 of the annular undersurface 210 may comprise a concave, dished, recessed, or tapered surface, without limitation. The first portion 212 may be surrounded by the second portion 236 and more proximate to the aperture 180.

In some embodiments (FIGS. 4 and 5), a disperser hood 136 may be integrally-provided to the slurry vortex stabilizer 166. An upper collar 184 defining an upper collar rim 186 may extend around the body 234 of the slurry vortex stabilizer 166 to form a gap 190 (most clearly seen from FIG. 4) between an outer peripheral surface 188 of the slurry vortex stabilizer 166 and the upper collar 184. The gap 190 may define a pocket or recess which is configured to receive a portion of the standpipe 152, such as a lower standpipe region 168. A number of mounting features 194 may be provided to the upper collar 184 to enable securement of the upper collar 184 (and thus, slurry vortex stabilizer 166) to the standpipe 152. Each of the mounting features 194 may comprise one or more apertures, holes, openings, or other means for accepting fasteners, such as bolts, pins, or screws, without limitation. The mounting features 194 may be provided to mounting bosses 192 for extra length of engagement, without limitation.

In some embodiments (e.g., as shown in FIGS. 6-10), the upper collar 184 may be modularly-configured with separable upper 184a and lower 184b portions. The upper portion 184a may, for example, comprise a portion of a separable disperser 134 having a tube portion 238 below it—the tube portion 238 being configured to surround vanes 116 of the rotor 114. The lower portion 184b of the upper collar 184 may comprise a portion of a separable disperser hood 136.

In any of the embodiments disclosed herein, disperser hood 136 may comprise a lower bell 196 (e.g., flared frustoconical flange) extending radially outwardly and downwardly from the upper collar 184 from a collar-bell intersection 198. The lower bell 196 may therefore be provided below upper collar 184 and extend therefrom proximate the collar-bell intersection 198. The lower bell 196 may comprise an upper bell surface 202, a lower bell surface 208, a lower outer peripheral edge defining a radially-outermost profile or periphery of the lower bell 196, and perforations or a number of openings 204 extending through the lower bell 196 and its upper 202 and lower 208 surfaces.

In some embodiments, one or more mounting features 232 may be provided to the outer peripheral surface 188 of the body 234. Each of the mounting features 232 may comprise an aperture or hole for securing a fastener (e.g., bolt, pin, screw) to an optional disperser 134 and/or disperser hood 136. In such embodiments, one or more mounting features 240, 244 (e.g., aperture, hole) aligned and complimentary with mounting features 232 may be provided to the disperser 134 and disperser hood 136, respectively. A fastener, such as a bolt, pin, or screw (not shown) may engage the mounting features 232, 240, 244, to secure the slurry vortex stabilizer 166, disperser 134, and disperser hood 136 together. While not shown, the disperser 134 may be omitted from the assembly such that the disperser hood 136 may be coupled directly to the body 232 of the slurry vortex stabilizer 166 via mounting features 232, 244 in the absence of a disperser 134 therebetween.

It should be understood that in some embodiments, while not shown, the disperser 134 may be optionally omitted from the froth flotation cell 100 and slurry vortex stabilizer 166/disperser hood 136 assembly. It should further be understood that while not shown, in some embodiments, disperser hood 136 may comprise a number of vanes (e.g., radially-inwardly and downwardly-extending scalloped vanes) extending from lower bell surface 208. The vanes extending from the lower bell surface 208 (not shown) may comprise, for example, those shown and disclosed in Applicant's co-pending patent application U.S. Ser. No. 62/975,475 filed 12 Feb. 2020, which is incorporated by reference in its entirety, for any and all purposes, as if fully set forth herein.

Turning to FIGS. 6-10, a slurry vortex stabilizer 166 may comprise a central hub 220. The central hub 220 may be provided as a tubular structure, a barrel-shaped structure, or a thin-walled cylinder, or similar structure, without limitation. The central hub may take forms other than what is shown in the figures. The central hub 220 may comprise an external wall 224. External wall 224 may comprise planar surfaces (e.g., it may be faceted), and/or it may comprise smooth or curved surfaces, without limitation. The external wall 224 generally defines a radially-outward surface portion of the central hub 220. As previously mentioned above, the body 234 of the slurry vortex stabilizer 166 may comprise an annular upper rim or projection 226 bounded by upper annular edge 176.

A number of webs 218 may extend between the annular upper rim or projection 226 and the central hub 220 as shown. The webs 218 may, according to some non-limiting embodiments, may comprise triangular, radially-extending, stationary vanes, without limitation. The webs 218 may be skewed, curved, slanted, obliquely-arranged, offset, or canted with respect to: the rotational axis 118, a radial direction 118′, or a direction 118″ which is transverse to the radial direction 118′ (e.g., a tangential direction), without limitation.

The webs 218 may define a number of upper pockets 216 therebetween. Each upper pocket 216 may be defined between surfaces of webs 218, an angled floor 222, and the external wall 224 of the central hub 220. A hub/floor interface 228 may define a lower corner edge of an upper pocket 216 in a radial direction along the angled floor 222, without limitation. A web/floor interface 230 may define a lower corner edge of an upper pocket 216 in a direction 118″ which is transverse to the radial direction 118′ (e.g., a tangential direction) along the angled floor, without limitation.

Although the invention has been described in terms of particular embodiments and applications, one of ordinary skill in the art, in light of this teaching, can generate additional embodiments and modifications without departing from the spirit of or exceeding the scope of the claimed invention.

Nomenclature and technical terms used in this description and the claims to define features has been chosen for convenience, and it should be understood that specific terms used herein may be replaced with art-recognized equivalents. For example, while the term “slurry vortex stabilizer 166” has been arbitrarily chosen and used consistently throughout this specification and in the claims, this term could be obviously replaced with similar terms like “vortex stabilizer,” “stabilizing structure,” “vortex prevention means,” “structure for preventing slurry vortex formation,” “structure for mitigating effects of slurry vortex formation,” “standpipe isolation device,” “standpipe seal,” “baffle between standpipe and drive shaft,” “sealing structure,” “slurry wave prevention apparatus,” and the like, without departing from the scope and spirit of the invention.

Accordingly, it is to be understood that the drawings and descriptions herein are proffered by way of example to facilitate comprehension of the invention and should not be construed to limit the scope thereof.

### REFERENCE NUMERAL IDENTIFIERS

A Longitudinal axis
B Longitudinal axis
D Longitudinal axis
2 Standpipe (or tube)
3 General direction (e.g., downward)
4 Rotor (or impeller)
5 General direction (e.g., upward)
6 Slurry vortex
7 General direction (e.g., radially-outwardly, lateral, transverse)
100 Self-aspirated froth flotation cell
110 Cylindrical draft tube
112 Tank
114 Rotor (or impeller)
116 Vane
118 Axis of rotation (of impeller 114, drive shaft 142)
118′ Radial direction (e.g., towards axis of rotation 118, longitudinal axis D, drive shaft 142, or center of tank 112)
118″ Direction transverse to radial direction 118′ (e.g., tangential direction)
125 Cylindrical draft tube extension or spacer element
126 Conical draft tube
128 Lower wall or panel
130 Supports
132 Opening(s)
134 Stationary fenestrated disperser
136 Disperser hood
140 Motor
142 Drive shaft
144 Transmission belt(s)
146 Sheave(s)
148 Sheave(s)
150 Mechanism stand
152 Standpipe (or tube)
154 Belt guard
156 Bearing housing
158 Slide gate air control device
160 Overflow weir (or launder)
162 Pipe for spraying wash water (e.g., galvanized pipe)
164 Nozzle element for spraying wash water
166 Slurry vortex stabilizer (i.e., slurry vortex 6 stabilizer or stabilizing structure therefor, structure for preventing slurry vortex 6 formation, structure for mitigating effects of slurry vortex 6 formation, standpipe isolation device, seal or baffle between standpipe 152 and drive shaft 142)
168 Lower standpipe region
170 Direction of rotation (e.g., clockwise as shown)
172 Velocity vector (e.g., somewhat upward)
174 Concave dished upper surface (e.g., frusto-spherical surface)
176 Upper annular edge
178 Upper inner edge
180 Aperture
182 Inner surface (e.g., cylindrical surface)
184 Upper collar
184a Modular upper portion (of upper collar 184)
184b Modular lower portion (of upper collar 184)
186 Upper collar rim
188 Outer peripheral surface
190 Gap
192 Mounting boss
194 Mounting feature (e.g., aperture, hole)
196 Lower bell (e.g., flared frustoconical flange)
198 Collar-bell intersection
200 Lower inner edge
202 Upper bell surface
204 Perforations or openings
206 Lower outer peripheral edge
208 Lower bell surface
210 Annular undersurface
212 First portion (e.g., convex, frustospherical, or frustoconical surface)
214 Intersection, transition, inflection
216 Upper pockets
218 Webs (e.g., generally triangular, radially-extending, stationary vanes)
220 Central hub (e.g., tubular, barrel-shaped, thin-walled cylinder)
222 Angled floor (e.g., faceted, frustoconical, frustopherical, concave, dished)
224 External wall (of hub 220) (e.g., radially-outward surface or surface portions)
226 Annular upper rim or projection
228 Hub/floor interface
230 Web/floor interface
232 Mounting feature (e.g., aperture, hole)
234 Body
236 Second portion (e.g., concave, dished, or tapered surface)
238 Tube portion
240 Mounting feature (e.g., aperture, hole)
242 Sloped upper (i.e., top) surface
244 Mounting feature (e.g., aperture, hole)

What is claimed:

1. A slurry vortex stabilizer 166, for placement within a tank 112 of a self-aspirated froth flotation cell 100, the slurry vortex stabilizer 166 being configured for placement above a rotor 114 of
the self-aspirated froth flotation cell 100 and being configured to surround a drive shaft 142 supporting and driving rotation of the rotor 114, the slurry vortex stabilizer 166 comprising:
an annular body 234 having an upper annular edge 176 and an aperture 180, the aperture 180 extending through a central region of the annular body 234, the aperture 180 having an inner surface 182 bounded between an upper inner edge 178 and a lower inner edge 200 and being configured to allow the drive shaft 142 to rotate freely therein in close proximity to the inner surface 182;
an annular undersurface 210 comprising an inner first portion 212, a second portion 236 provided around the first portion 212, and an annular intersection, transition, or inflection 214 therebetween; and,
a sloped upper surface 242 which tapers downwardly towards the central region of the annular body 234 as it approaches the aperture 180;
wherein the undersurface 210 of the annular body 234 is configured to be provided radially-inwardly of a disperser hood 136 in the self-aspirated froth flotation cell 100.

2. The slurry vortex stabilizer 166 defined in claim 1, wherein the first portion 212 is located radially-inwardly of the second portion 216 with respect to an axis of rotation 118 of the drive shaft 142 and/or rotor 114, and wherein the first portion 212 is located closer to the aperture 180, lower inner edge 200, and/or inner surface 182 of the aperture 180 than the second portion 216.

3. The slurry vortex stabilizer 166 defined in claim 1, wherein the aperture 180 extends concentrically through the annular body 234 such that radial distances between the upper inner edge 178 and upper annular edge 176 are equidistant around the slurry vortex stabilizer 166.

4. The slurry vortex stabilizer 166 defined in claim 1, wherein the sloped upper surface 242 comprises a concave dished upper surface 174.

5. The slurry vortex stabilizer 166 defined in claim 4, wherein the concave dished upper surface 174 comprises a frustospherical surface.

6. The slurry vortex stabilizer 166 defined in claim 1, wherein the sloped upper surface 242 comprises an angled floor 222.

7. The slurry vortex stabilizer 166 defined in claim 6, wherein the angled floor 222 comprises a faceted surface, a frustoconical surface, a frustospherical surface, a concave surface, or a dished surface.

8. The slurry vortex stabilizer 166 defined in any claim 1, wherein the first portion 212 comprising a convex, frustospherical, or frustoconical surface.

9. The slurry vortex stabilizer 166 defined in claim 1, wherein the second portion 236 comprises a concave, dished, or tapered surface.

10. The slurry vortex stabilizer 166 defined in claim 9, wherein the concave, dished, or tapered surface narrows towards the intersection or transition 214.

11. The slurry vortex stabilizer 166 defined in claim 1, further comprising a number of webs 218 extending upwardly from the sloped upper surface 242, and define at least one interface 230 therebetween.

12. The slurry vortex stabilizer 166 defined in claim 11, wherein the webs 218 are provided between the upper annular edge 176 and an external wall 224 of a central hub 220, and define at least one interface 228 therebetween.

13. The slurry vortex stabilizer 166 defined in claim 1, further comprising a disperser hood 136.

14. The slurry vortex stabilizer 166 defined in claim 13, wherein the disperser hood 136 is integrally provided to the slurry vortex stabilizer such that the slurry vortex stabilizer 166 and disperser hood 136 share a monolithic and unitary structure.

15. The slurry vortex stabilizer 166 defined in claim 13, wherein a gap 190 is provided between an outer peripheral surface 188 of the annular body 234 and an upper collar 184 of the disperser hood 136 for receiving a lower portion of a standpipe 152 within the self-aspirated froth flotation cell 100.

16. The slurry vortex stabilizer 166 defined in claim 15, wherein the upper collar 184 comprises at least one mounting feature 194 for mounting the upper collar 184 to the standpipe 152.

17. The slurry vortex stabilizer 166 defined in claim 13, wherein the disperser hood comprises a lower bell 196 extending downwardly and radially-outwardly from the upper collar 184, the lower bell comprising an upper bell surface 202, a lower bell surface 208, a lower outer peripheral surface 206, and a number of perforations or openings 204 extending through the lower bell surface 208 and the upper 202 and lower 208 bell surfaces.

18. The slurry vortex stabilizer 166 defined in claim 17, wherein the upper bell surface 202 and lower bell surface 208 are frustoconical.

19. The slurry vortex stabilizer 166 defined in claim 15, wherein the sloped upper surface 242 of the body 234 is configured to form a lower fluid boundary surface within the standpipe 152.

20. The slurry vortex stabilizer 166 defined in claim 1, further comprising one or more mounting features 232 for securing the annular body 234 to a separable detachable disperser hood 136 and/or to a separable detachable disperser 134.

21. The slurry vortex stabilizer 166 defined in claim 20, wherein the slurry vortex stabilizer 166 is configured for attachment to both the disperser 134 and disperser hood 136 via the one or more mounting features 232.

22. The slurry vortex stabilizer 166 defined in claim 1, wherein the body 234 is located radially inward from the disperser 134 and/or the disperser 134 surrounds an outer peripheral surface 188 annular body 234.

23. The slurry vortex stabilizer 166 defined in claim 1, comprising an upper collar 184.

24. The slurry vortex stabilizer 166 defined in claim 23, wherein the upper collar 184 is modular and comprises an upper portion 184a defining a portion of a disperser 134, and a lower portion 184b defining a portion of a disperser hood 136, the upper portion 184a being separable from the lower portion 184.

25. The slurry vortex stabilizer 166 defined in claim 1, wherein the sloped upper surface the annular body 234 is configured to be provided radially inward of surfaces of a disperser 134 or disperser hood 136 within the self-aspirated froth flotation cell 100.

26. (canceled)

27. A self-aspirated froth flotation cell 100 comprising the slurry vortex stabilizer 166 defined claim 1.

28. A method of performing a flotation operation comprising:
providing the slurry vortex stabilizer 166 defined in claim 1 within the tank 112 of the self-aspirated froth flotation cell 100, around the drive shaft 142 and above the rotor 114 such that the inner surface 182 of the aperture 180 surrounds the drive shaft 142;
rotating the rotor 114 and drive shaft 142 while slurry is held within the tank 112; and
drawing air into the slurry within the tank 112; and
preventing formation of a slurry vortex 6 or waves in the slurry in the tank by virtue of the provision of the slurry vortex stabilizer 166 within the tank 112.
